(19) United States
(12) Patent Application Publication
(10) Pub. No.: US 2026/0116384 A1
(43) Pub. Date: Apr. 30, 2026

(54) PERSONALIZED DRIVER HEADWAY FOR ADAPTIVE CRUISE CONTROL

(71) Applicant: GM Global Technology Operations LLC, Detroit, MI (US)

(72) Inventors: Kevin A. O'Dea, Ann Arbor, MI (US); Mohammadali Shahriari, Markham (CA); Ashraf Abualfellat, Grand Blanc, MI (US)

(21) Appl. No.: 18/930,418

(22) Filed: Oct. 29, 2024

(51) Int. Cl. B60W 30/16; B60W 50/00

(52) U.S. Cl. CPC B60W 30/16; B60W 50/00; B60W 2050/0028; B60W 2050/0054; B60W 2554/40; B60W 2554/802; B60W 2555/20; B60W 2720/10; B60W 2754/30

(57) ABSTRACT

A vehicle includes at least one sensor in communication with a controller. The controller includes a ranging module configured to determine a headway between the vehicle and a lead vehicle traveling ahead of the vehicle. The controller also includes a headway learning module and an adaptive cruise control module. The headway learning module is configured to learn a set of personalized headways while the adaptive cruise control module is not engaged. The adaptive cruise control module is configured to maintain the vehicle at a personalized headway from the lead vehicle when the active cruise control module is engaged.

The subject disclosure relates to vehicles, and in particular to cruise control systems for vehicles.

Traditional cruise control systems for vehicles set a desired speed, and maintain the vehicle at that speed regardless of the flow of traffic, road conditions, or other factors. Adaptive Cruise Control (ACC) is a type of advanced driver-assistance for road vehicles that automatically adjusts the vehicle speed to maintain a predetermined distance between it and a leading vehicle instead of maintaining a set speed. ACC can alternately be referred to as dynamic cruise control, as well as multiple other similar terms.

Current adaptive cruise control systems allow an operator to select a distance from a set of predetermined distances, and the ACC system maintains the vehicle at the selected distance from any vehicle ahead of the vehicle operating the ACC system. Such systems do not account for operator preferences, and/or driving styles, driver reaction times, and/or braking distances beyond the ability for the operator to manually select a distance to one of a predetermined set of distances to be maintained.

Accordingly, it is desirable to provide an adaptive cruise control system able to account for driver preferences and driving styles and able to account for current conditions.

### SUMMARY

In one exemplary embodiment A vehicle includes at least one sensor in communication with a controller. The controller includes a ranging module configured to determine a headway between the vehicle and a lead vehicle traveling ahead of the vehicle. The controller also includes a headway learning module and an adaptive cruise control module. The headway learning module is configured to learn a set of personalized headways while the adaptive cruise control module is not engaged. The adaptive cruise control module is configured to maintain the vehicle at a personalized headway of the set of personalized headways from the lead vehicle when the active cruise control module is engaged.

In addition to one or more of the features described herein each personalized headway in the set of personalized headways corresponds to a unique set of conditions.

In addition to one or more of the features described herein, the unique set of conditions includes at least one of a speed condition, a traffic condition, a road condition, and a weather condition.

In addition to one or more of the features described herein the unique set of conditions includes at least two distinct conditions.

In addition to one or more of the features described herein the headway learning module includes a neural network trained using a training set of training headways with each training headway having a corresponding set of conditions.

In addition to one or more of the features described herein the headway learning module includes a statistical model configured to estimate the headway over time.

In addition to one or more of the features described herein the statistical model is a Kalman filter.

In addition to one or more of the features described herein the estimated headway over time is determined according to the following equation: HdwyEstMeas=(LeadVehDistance/(max(Vx,1)))+Uncertainty, where HdwyEstMeas is the estimated personalized headway, LeadVehDistance is a measured physical distance between the vehicle and the lead vehicle, Vx is a current velocity of the vehicle, and uncertainty is an uncertainty value of the Kalman filter.

In addition to one or more of the features described herein the set of personalized headways are driver specific headways.

In addition to one or more of the features described herein the set of personalized headways associated with the driver is stored in a matrix having a plurality of cells, and wherein each cell of the plurality of cells corresponds to a distinct set of unique conditions.

In another exemplary embodiment a process for generating personalized adaptive cruise control headways includes: monitoring a vehicle headway during a learn mode of operations and storing the monitored vehicle headway as a learned headway. The monitoring includes identifying at least one current condition and correlating the at least one current condition with the learned headway. The method accumulates a sample set of learned headways having the same at least one current condition until the sample set of learned headways has a sample size larger than a predefined minimum sample size. The method combines the sample set of learned headways into a single personalized headway and providing the single personalized headway to an adaptive cruise control unit.

In addition to one or more of the features described herein, combining the sample set of learned headways comprises performing a statistical analysis of the sample set of learned headways.

In addition to one or more of the features described herein the statistical analysis includes estimating a headway over time by applying a Kalman filter to the sample set of learned headways.

In addition to one or more of the features described herein the estimated headway over time is determined according to the following equation: HdwyEstMeas=(LeadVehDistance/(max(Vx,1)))+Uncertainty, where HdwyEstMeas is the personalized headway, LeadVehDistance is a measured physical distance between the vehicle and the lead vehicle, Vx is a current velocity of the vehicle, and uncertainty is an uncertainty value of the Kalman filter.

In addition to one or more of the features described herein combining the sample set of learned headways comprises providing the sample set of learned headways and the corresponding at least one condition as a training set of training headways to a neural network.

In addition to one or more of the features described herein combining the sample set of learned headways into a single personalized headway further comprises storing the single personalized headway in a cell of a matrix.

In addition to one or more of the features described herein the matrix defines a plurality of cells, and wherein each cell corresponds to a distinct set of unique conditions correlated with a headway stored in the cell.

In addition to one or more of the features described herein providing the single personalized headway to the adaptive cruise control unit comprises identifying at least one vehicle condition and identifying a cell of the matrix, where the unique set of conditions of the identified cell match the at least one vehicle condition and the provided single personalized headway is a personalized headway stored in the cell of the matrix.

In addition to one or more of the features described herein, the process includes operating the adaptive cruise control using the single personalized headway.

In addition to one or more of the features described herein the matrix is a driver specific matrix.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle according to an embodiment;

FIG. 2 is a high-level process for operating an adaptive cruise control system according to an embodiment;

FIG. 3 illustrates an operation of a vehicle without the adaptive cruise control system engaged according to an embodiment;

FIG. 4 illustrates an operation of a vehicle with the adaptive cruise control system engaged according to an embodiment; and

FIG. 5 illustrates a process of operating a driver-specific adaptive cruise control system for a vehicle according to an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the control process.

As used herein, a “headway” between a first vehicle (a leading vehicle) and a second vehicle (a following vehicle) traveling along the same trajectory is an amount of time taken for the second vehicle to reach a position held by the first vehicle. By way of example, if the leading vehicle passes a marker along a trajectory, the headway is the amount of time taken for the following vehicle to pass the same marker along the same trajectory. As can be appreciated, knowledge of a current speed of the following vehicle and the headway allows for an instantaneous distance between the following vehicle and the leading vehicle to be simply calculated by multiplying the headway time by the current speed. By defining the headway in units of time, a process or operator can accurately accommodate reaction times and braking times by using a base headway and adding the reaction time and/or braking time to the base headway. This adjustment can be performed independent of a current speed of the vehicle using relatively simple calculations.

Adaptive cruise control systems typically use a gap distance between the leading vehicle and the following vehicle as a proxy for headway and allow the gap distance to be adjusted by a user to one of a limited number of predefined gap distances (e.g., 20 feet, 30 feet, 40 feet). The adaptive cruise control then uses the speed of the following vehicle to calculate the corresponding headway and maintains that headway throughout operation of the adaptive cruise control. In the existing adaptive cruise control systems, the preset gap distances cannot be tailored to preferred driving characteristics of a specific driver.

One or more embodiments described herein utilizes two modes. A first “learn mode” monitors headways during a driver's vehicle operations and stores the monitored headways as a set of learned headways. In addition, the learning mode tracks a set of current conditions (e.g. road condition, weather condition, traffic condition, speed limit, and road type) and associates each monitored headway with the corresponding current conditions in the learned headways set. The learn mode functions while the adaptive cruise control is not active.

Using the set of learned headways, the vehicle adjusts adaptive cruise control headways stored in the adaptive cruise control from initial preset values to values corresponding to the headways in the set of learned headways.

This method and process continuously monitors the driver's style of driving in different environmental conditions and situations and learns the driver's preferred headway(s) (the monitored headways) for given sets of conditions.

In one implementation of the control system described herein, a vehicle includes a controller that monitors headways for the vehicle, while the vehicle is in the learn mode. The controller associates the determined headway with one or more available corresponding conditions (e.g. weather type, road condition, road type, speed limit, etc.) of a driver during the learn mode, and stores the monitored headways and associate conditions in the set of learned headways. After accumulating a sufficient sample size of monitored headways (e.g., greater than a threshold amount), the controller determines personalized headways for the driver matching the driver's personal driving style and the determined personalized headways are implemented in a personalized adaptive cruise control system.

In one instance of the implementation the monitored headways are correlated into personalized headways using statistical modeling techniques, such as Kalman filtering.

In another instance of the implementation the learned headways are processed as a training set for a neural network along with the corresponding conditions, and the neural network is trained using the training set to allow the adaptive cruise control to generate determined headways based on the current conditions of the vehicle.

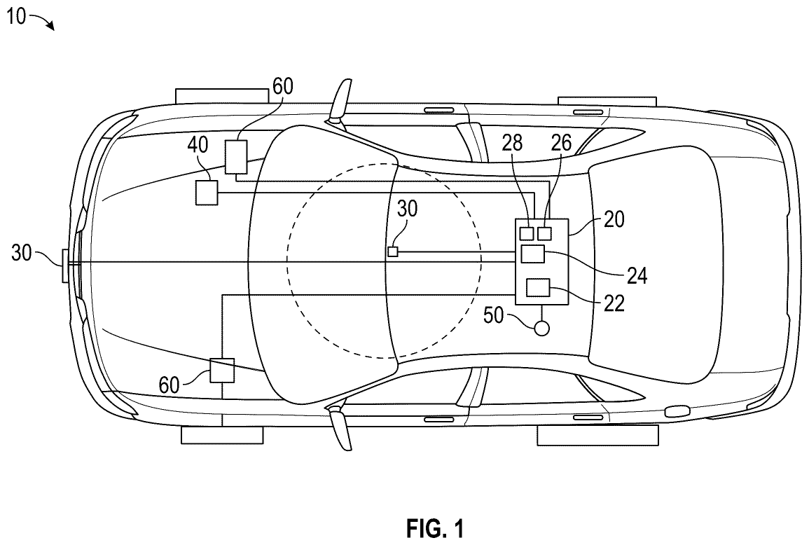

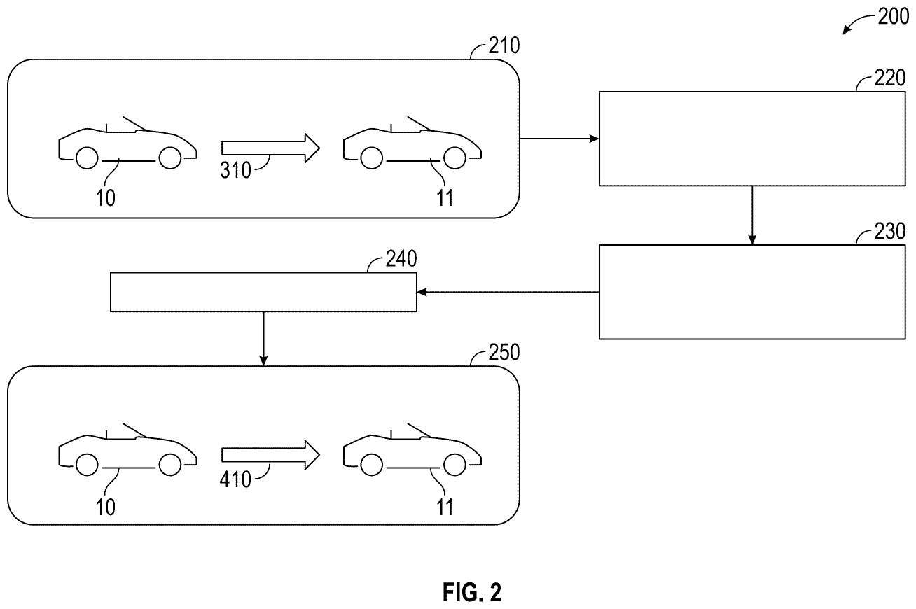

In accordance with an embodiment, FIG. 1 illustrates a vehicle 10 including a cruise control controller (controller 20). The controller 20 includes a headway learning module 22 and a personal adaptive cruise control module 24. The controller 20 is further connected to at least one imaging and/or ranging sensor (sensor 30) (e.g., a camera, a radar device, a lidar device, and/or the like, including combinations and/or multiples thereof), with the sensor 30 being configured to provide the controller 20 with sufficient information to detect a headway between the vehicle 10 (the following vehicle) and a second vehicle 11 (the leading vehicle, illustrated in FIGS. 2-4) in front of the vehicle 10.

In some examples the controller 20 is configured to detect the current headway of the vehicle 10 based solely on image data. In another example, the controller 20 is configured to detect a current headway of the vehicle 10 based on ranging data. In yet further examples, the controller 20 may also include a communication module 28 having at least one of vehicle to vehicle (V2V) and Vehicle to infrastructure (V2X) communication capabilities, allowing the vehicle 10 to receive current headway information communicated from another vehicle or system. In addition, the controller 20 is connected with a speed sensor 40, with the speed sensor 40 providing vehicle speed feedback data to the controller 20.

A condition input 50 provides the controller 20 with one or more data points regarding the conditions in which the vehicle 10 is currently operating. As used herein, the conditions of the vehicle refer to any operational or environment parameters in which the vehicle is currently operating and which may impact reaction times and/or braking times, and thus require an adjustment to a the personalized headway of the adaptive cruise control. The conditions may be received from other controllers on the vehicle 10, vehicle sensors including but not limited to the sensors 30, global navigation satellite systems (GNSS), online data sources, such as a national weather service, internet-based map services, and the like.

The adaptive cruise control module 24 provides control outputs to one or more vehicle systems, such as drive motors 60. The control outputs effect vehicle operative controls which operate the vehicle 10 using any adaptive cruise control methodology combined with the personalized headways.

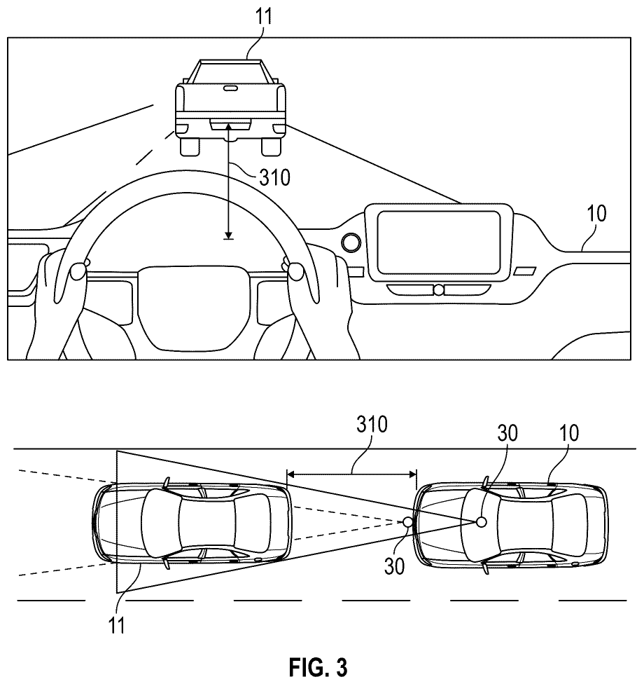

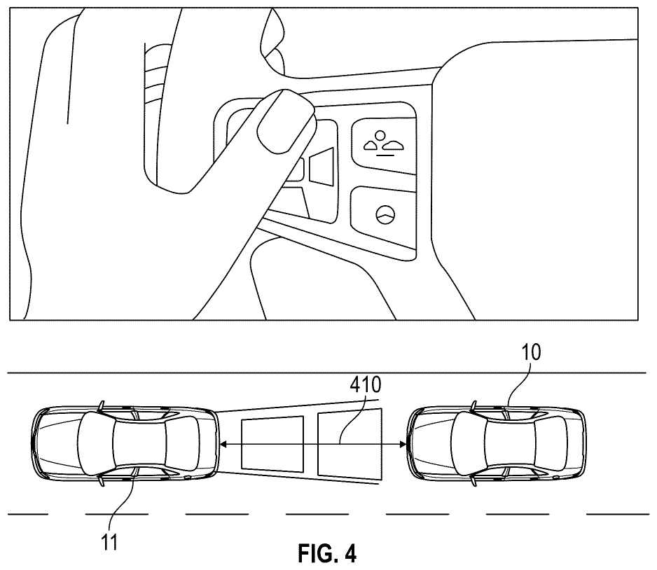

Aspects of the vehicle 10 of FIG. 1 are further described with respect to FIGS. 2, 3, and 4 as follows. FIG. 2 illustrates an example high level process 200 for operating the adaptive cruise control system. FIG. 3 illustrates operation of the vehicle 10 without the adaptive cruise control systems engaged (referred to as the adaptive cruise control system being inactive). FIG. 4 illustrates an example operation of the vehicle 10 with the adaptive cruise control system engaged (referred to as the adaptive cruise control system being active).

Initially during operation of the vehicle 10 while the adaptive cruise control is inactive (FIG. 3), a learn mode is engaged. During the learn mode the controller 20 monitors a headway 310 using the sensor(s) in an initial determine headways step 210. During a first instance of operating the learn mode, the driver calibrates the controller by manually selecting a headway from a set of preset headways corresponding to the current headway of the vehicle 10. The controller then calibrates a learning vector to set the current headway of the vehicle 10 as being the manually selected headway. The calibration of the learning vector ensures that subsequent operations of the learn mode are provided a singular calibration value, thus normalizing the operations.

As the monitored headways are accumulated in a set of learned headways, the set of learned headways is stored in a memory 26 in the controller 20, or at another location accessible by the controller 20. Once sufficient headways have been accumulated in the set of learned headways, the headway learning module 22 uses a statistical modeling system to estimate personalized headways based on the full set of learned headways in an estimate personalized headways step 220. In one example, the statistical model utilized is a Kalman filter. In alternative examples alternative statistical modeling may be utilized.

As the process continues, additional learned headways are accumulated, and the personalized headways are refined into a single personalized headway for use in the adaptive cruise control in a refine estimates step 230. In systems where road conditions, such as weather, road type, location, time of day, etc., are correlated with the monitored headways determined in the determine headways step 210, the statistical model of step 220 and the refine estimates step 230 are performed for each available condition, or set of conditions, and a single personalized headway is generated corresponding to each condition or set of conditions. By way of example, if the set of conditions available include a road type of paved or unpaved and a time of day of day or night, a distinct personalized headway is generated for each of Paved/Day, Paved/Night, Unpaved/Day, and Unpaved/Night, resulting in four distinct personalized headways, with the controller 20 utilizing whichever personalized headway corresponds to the current conditions of the vehicle 10.

In such an example, the personalized headways are stored in a matrix with each cell of the matrix corresponding to a unique set of conditions correlated with the specific headway stored in the cell. One such example Matrix (Matrix I) is illustrated below with conditions of traffic (leftmost column) and speed of the vehicle to nearest 10 miles per hour (top row):

Matrix I

| | | | | |
|---|---|---|---|---|
| Speed/Traffic | 0 | 10 | 20 | 30 |
| Stop and Go | 2.25 | 2.1 | 1 | 1 |
| Heavy | 1.5 | 1 | 0.8 | 0.8 |
| Normal | 2 | 1.25 | 1 | 0.8 |

While a simple two condition matrix is illustrated for explanatory effect, it is understood that the matrix may be a multi-dimension matrix and accommodate any number of conditions, as well as any number of values for those conditions, with the limits on the matrix size being practical computer processing limits.

In one particular example, the controller 20 uses a Kalman/Adaptive Filter Learn process on the set of learned headways to generate the set of personalized headways while the adaptive cruise control is not active and the driver is in full control of the vehicle 10. As the vehicle 10 continues to operation, the controller 20 estimates a continuous headway (a headway over time) using a Kalman filter. For example, the following equation can be used to determine a personalized headway:

HdwyEstMeas = (LeadVehDistance/(max(Vx, 1))) + Uncertainty

where HdwyEstMeas is the personalized headway, LeadVehDistance is a measured physical distance between the vehicle 10 and the lead vehicle 11, Vx is a current velocity of the vehicle 10, and uncertainty is an uncertainty value of the Kalman filter.

When the HdwyEstMeas value (the personalized headway) converges (maintains at a single value, within a margin or error) for a particular speed range and/or range of other conditions, the value is stored as a finalized value. In some examples, a covariance is used to ensure that the finalized valued cannot be below or above a minimum or maximum (respectively) allowed value. Once stored as a finalized, the process 200 records that the cell of the matrix corresponding to the condition set of the finalized value has been learned and is able to be implemented in adaptive cruise control at step 250.

After the cell of the matrix has been learned, the process 200 validates the finalized values in the matrix by incrementing a “valid count” for each cell of the matrix that contains a learned value. When the valid count is greater than a predefined constant value (Kcnt), the personalized is considered to be conditionally valid, and the process 200 performs a check for final validity confirmation.

The check for final validity confirmation identifies the difference between each cell of the matrix and each other cell of the matrix and verifies that all of the differences are less than a predetermined acceptable value. When all differences are less than the predetermined acceptable value, the check for final validity confirmation is passed, and the learned headway is considered to be fully valid.

Once a sufficient set of fully valid headways is determined, the process 200 proceeds to the combine estimates step 230, where the personalized headways are combined into a final set of personalized headways that is useable by the adaptive cruise control.

The final set of personalized headways are provided to the adaptive cruise control module 24 in a provide headways step 240. Using the adaptive cruise control module 24, the vehicle 10 maintains a headway 410 matching the provided headway corresponding to the current conditions of the vehicle 10.

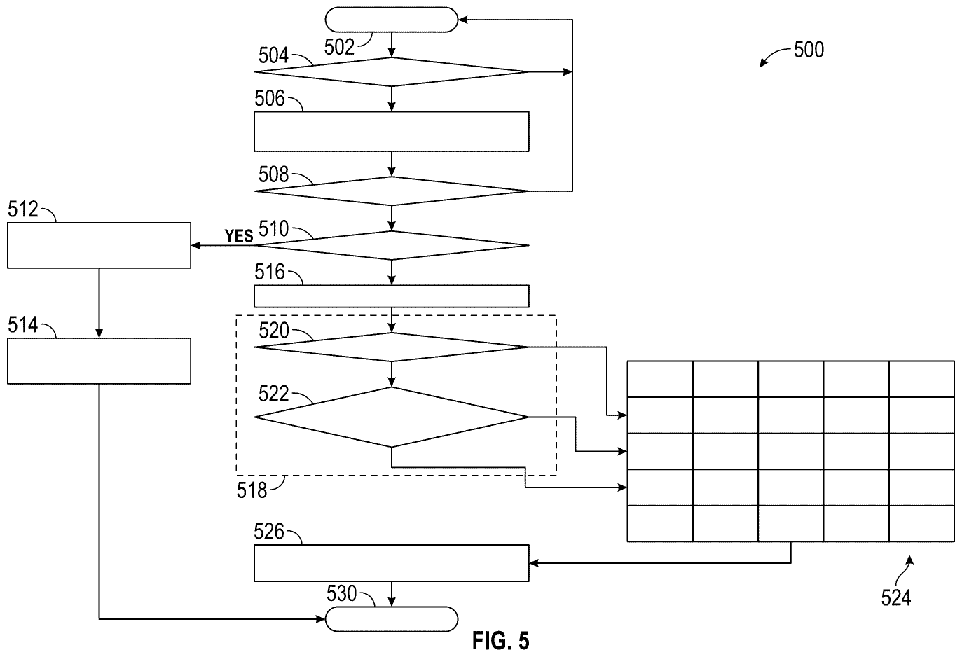

With continued reference to FIGS. 1-4, FIG. 5 illustrates a more detailed example process 500 for learning particular headways for a given driver. Initially, the process 500 begins at a start step 502. The start step 502 may be initiated automatically upon recognition of the driver and engaging the vehicle 10 in a mode other than an adaptive cruise control mode. In alternate examples, the start step 502 may be initiated manually by the driver or other vehicle operator using any manual process initiation.

After the process 500 has initiated, the controller 20 monitors for a second vehicle 11 ahead of the driver in a lead vehicle check 504. If no lead vehicle 11 is detected at step 504, the process 500 returns to the start step 502. As long as the driver or other vehicle operator does not forcibly stop the learn mode, the process 500 loops through the start step 502 and the lead vehicle check 504 until a second vehicle (lead vehicle 11) ahead of the vehicle 10 is detected.

When a lead vehicle 11, ahead of the vehicle 10, is detected at step 504, the process 500 proceeds to step 506, where the process 500 determines a vehicle stability value that indicates how steady the current headway is. At step 508, the process 500 determines if the vehicle is stable (i.e., the headway does not vary beyond a margin of error over time) in a stability check by comparing the vehicle stability value determined at step 506 to a threshold. When the vehicle 10 is determined not to be stable at step 508 (i.e., the determined vehicle stability value is less than the threshold), the process 500 returns to the start step 502.

When the vehicle 10 is determined to be stable at step 508 (i.e., the determined vehicle stability value is greater than or equal to the threshold), the process 500 proceeds to step 510 and determines whether the driver has engaged the adaptive cruise control system.

When the adaptive cruise control system is active, the process 500 proceeds to step 512 and extracts the learned headway corresponding to current conditions from a matrix 524 of learned headways. Matrix I, above, provides a simplified example matrix illustration for the matrix 524. The process 500 then proceeds to step 514 and passes the headway value to the controller 20. The process 500 ends at an end step 530.

When the adaptive cruise control system is not active at step 510, the process 500 begins storing monitored headways in the set of learned headways at step 516. The step 516 includes performing a sequence 518 of checks, with each check corresponding to one potential vehicle condition. In the illustrated example, the sequence 518 of checks includes a check 520 to determine if the vehicle 10 is in stop and go traffic and a check 522 to determine if the vehicle 10 is in heavy traffic. In other examples, the sequence 518 of checks can include any number and/or type of conditions, including weather, road type, vehicle location, or any other available condition.

The results of each check 520, 522 are provided to the matrix 524, with the combined results identifying a cell in the matrix 524 corresponding to the current set of conditions. Once the matching cell has been identified, the process 500 calculates the headways and validity in step 526. The step 526 can be performed according to the process 200 described with regards to FIG. 2-4. The process then ends in an end step 530.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
at least one sensor in communication with a controller, wherein the controller includes a ranging module configured to determine a headway between the vehicle and a lead vehicle traveling ahead of the vehicle; and
the controller including a headway learning module and an adaptive cruise control module, wherein the headway learning module is configured to learn a set of personalized headways while the adaptive cruise control module is not engaged, and wherein the adaptive cruise control module is configured to maintain the vehicle at a personalized headway of the set of personalized headways from the lead vehicle when the active cruise control module is engaged.

2. The vehicle of claim 1, wherein each personalized headway in the set of personalized headways corresponds to a unique set of conditions.

3. The vehicle of claim 2, wherein the unique set of conditions includes at least one of a speed condition, a traffic condition, a road condition, and a weather condition.

4. The vehicle of claim 3, wherein the unique set of conditions includes at least two distinct conditions.

5. The vehicle of claim 1, wherein the headway learning module includes a neural network trained using a training set of training headways with each training headway having a corresponding set of conditions.

6. The vehicle of claim 1, wherein the headway learning module includes a statistical model configured to estimate the headway over time.

7. The vehicle of claim 6, wherein the statistical model is a Kalman filter.

8. The vehicle of claim 7, wherein the estimated headway over time is determined according to the following equation:
HdwyEstMeas = (LeadVehDistance/(max(Vx, 1))) + Uncertainty;
where HdwyEstMeas is the estimated personalized headway, LeadVehDistance is a measured physical distance between the vehicle and the lead vehicle, Vx is a current velocity of the vehicle, and uncertainty is an uncertainty value of the Kalman filter.

9. The vehicle of claim 1, wherein the set of personalized headways are driver specific headways.

10. The vehicle of claim 1, wherein the set of personalized headways associated with the driver is stored in a matrix having a plurality of cells, and wherein each cell of the plurality of cells corresponds to a distinct set of unique conditions.

11. A process for generating personalized adaptive cruise control headways, the process comprising:
monitoring a vehicle headway, the monitoring occurring during a learn mode of operations, and storing the monitored vehicle headway as a learned headway during the learn mode of operations, wherein the monitoring includes identifying at least one current condition and correlating the at least one current condition with the learned headway;
accumulating a sample set of learned headways having the same at least one current condition until the sample set of learned headways having the same at least one current condition has a sample size larger than a predefined minimum sample size; and
combining the sample set of learned headways into a single personalized headway and providing the single personalized headway to an adaptive cruise control unit.

12. The method of claim 11, wherein combining the sample set of learned headways comprises performing a statistical analysis of the sample set of learned headways.

13. The method of claim 12, wherein the statistical analysis includes estimating a headway over time by applying a Kalman filter to the sample set of learned headways.

14. The method of claim 13, wherein the estimated headway over time is determined according to the following equation:
HdwyEstMeas = (LeadVehDistance/(max(Vx, 1))) + Uncertainty;
where HdwyEstMeas is the personalized headway, LeadVehDistance is a measured physical distance between the vehicle and the lead vehicle, Vx is a current velocity of the vehicle, and uncertainty is an uncertainty value of the Kalman filter.

15. The method of claim 12, wherein combining the sample set of learned headways comprises providing the sample set of learned headways and the corresponding at least one condition as a training set of training headways to a neural network.

16. The method of claim 11, wherein combining the sample set of learned headways into a single personalized headway further comprises storing the single personalized headway in a cell of a matrix.

17. The method of claim 16, wherein the matrix defines a plurality of cells, and wherein each cell corresponds to a distinct set of unique conditions correlated with a headway stored in the cell.

18. The method of claim 17, wherein providing the single personalized headway to the adaptive cruise control unit comprises identifying at least one vehicle condition and identifying a cell of the matrix, where the unique set of conditions of the identified cell match the at least one vehicle condition and the provided single personalized headway is a personalized headway stored in the cell of the matrix.

19. The method of claim 18, further comprising operating the adaptive cruise control using the single personalized headway.

20. The method of claim 11, wherein the matrix is a driver specific matrix.
